(19) United States
(12) Patent Application Publication
(10) Pub. No.: US 2017/0115686 A1
(43) Pub. Date: Apr. 27, 2017

(54) Method and Apparatus for Natural Clock Generation in the System

(71) Applicant: Thang Minh Tran, Saratoga, CA (US)

(72) Inventor: Thang Minh Tran, Saratoga, CA (US)

(21) Appl. No.: 14/919,760

(22) Filed: Oct. 22, 2015

(51) Int. Cl. G06F 1/12

(52) U.S. Cl. CPC G06F 1/12

(57) ABSTRACT

A digital circuitry comprising a processing unit that receives a first clock and comprising of a first self-clock circuitry that generates a first internal clock; wherein the said first self-clock circuitry further comprises of a mechanism to select between the said first clock and the first internal clock of the said processing unit for clock edge synchronization.

### RELATED PATENT

This application is a continuation-in-part of U.S. patent application Ser. No. 13/555,178, entitled “Method and Apparatus for Processor to Operate at Its Natural Clock in the System,” naming Thang Tran as inventor, and assigned to Thang Tran, and is hereby incorporated by reference.

### FIELD OF THE DISCLOSURE

The present disclosure relates to digital systems (such as mobile devices, internet-of-thing, processors, memory devices, and computer systems) and, more particularly, to mechanisms and techniques for clocking mechanism of the digital designs.

### BACKGROUND

In general, microprocessors (processors) achieve high performance by executing multiple instructions per clock cycle and by choosing the shortest possible clock cycle. The term “clock cycle” refers to an interval of time accorded to various stages of processing pipeline within the microprocessor. The phrase “instruction processing pipeline” is used herein to refer to the logic circuits employed to process instructions in a pipeline fashion. Although the pipeline may include any number of stages, where each stage processes at least a portion of an instruction, instruction processing generally includes the steps of: decoding the instruction, fetching data operands, executing the instruction and storing the execution results in the destination identified by the instruction.

Processor design consists of a central clock, generally phase lock loop (PLL) clock, with a clock tree network. The clock tree consists of many global clock buffers and local clock buffers. The clock buffers can be clock-gated to save power but the clock tree itself can still consume much power. In some estimate, the PLL and the clock tree can consume 15% to 35% of total dynamic power of the processor. The distributed clock networks with local clock generators can significant reduce the power consumption of microprocessor as suggested in U.S. Pat. No. 5,987,620. Unfortunately, at system level, the clocking network is still inefficient with a single PLL clock or multiple PLL clocks. Furthermore, the power requirements are different for different applications. The clock designs of extremely low power (10 micro Watt) of medical devices are much different than the clock designs of high performance server microprocessors (130 Watt). At system level, the globally-asynchronous-locally-synchronous (GALS) clocking allows the system modules to operate at different clock frequencies but these clocks are based on the fixed clock frequencies of PLL clocks.

### BRIEF DESCRIPTION OF THE DRAWINGS

The present disclosure may be better understood, and its numerous features and advantages made apparent to those skilled in the art by referencing the accompanying drawings. Embodiments of the present disclosure are illustrated by way of examples and are not limited by the accompanying figures, in which like references indicate similar elements. The use of the same reference symbols in different drawings indicates similar or identical items. Elements in the figures are illustrated for simplicity and clarity and have not necessarily been drawn to scale.

FIG. 1 is a block diagram of an embodiment of a prior-art computer processing system in accordance with the present disclosure.

FIG. 2 is a block diagram of an embodiment of implementing clock interfacing mechanism along with asynchronous FIFO (first-in-first-out) for a processing unit of the present disclosure.

FIG. 3 is a block diagram of an embodiment of a computer processing system in accordance with the present disclosure.

FIG. 4 is a block diagram of a self-clock circuitry to generate a natural clock of a processing unit of the present disclosure.

### SUMMARY

The problems outlined above are in large part solved by a design in accordance with the various embodiments of this disclosure. Embodiments of this disclosure are adaptable for use in any Mobile Device, Internet-of-Thing, computer systems, or other digital designs.

In particular, the disclosure contemplates on using the self-clock mechanism that will conditionally generate clocks when there is a valid operation to be performed. The self-clock modules are used for interface block of the processing unit for communication with other processing units. The interface block includes asynchronous buffers to allow the processing unit to receive and send data to other processing units with different clock frequencies. The self-clock modules within a processing unit are designed to operate at the same clock frequency which matches the worst-case speed path which is referred to as the natural clock frequency, or the target frequency of the processing unit. This mechanism will enable a power reduction mechanism at the processing unit level as well as system level. The system can include many processing units such as a general-purpose microprocessor, a DSP, a peripheral device, an I/O device, a sensor device, a hardware accelerator, and memory modules. In this disclosure, the processing unit is referred to all the above components, including memory modules, listed in the system. Instead of using a single or multiple PLL clocks to force these processing units to operate at certain clock frequencies, the processing units and memory modules should operate at their own natural clock frequencies. The natural clock module is designed in accordance with the design technology which matches the frequency of the pipeline operation of the processing unit. Furthermore, the self-clock module in each processing unit effectively is the clock gate mechanism to gate off the clock for the processing unit when there is no valid operation.

This disclosure provides various embodiments of mechanisms to generate clock only when there is a need to perform a valid operation.

A further understanding of the nature and advantages of the present disclosure may be realized by reference to the remaining portions of the specification and the drawings.

### DETAILED DESCRIPTION

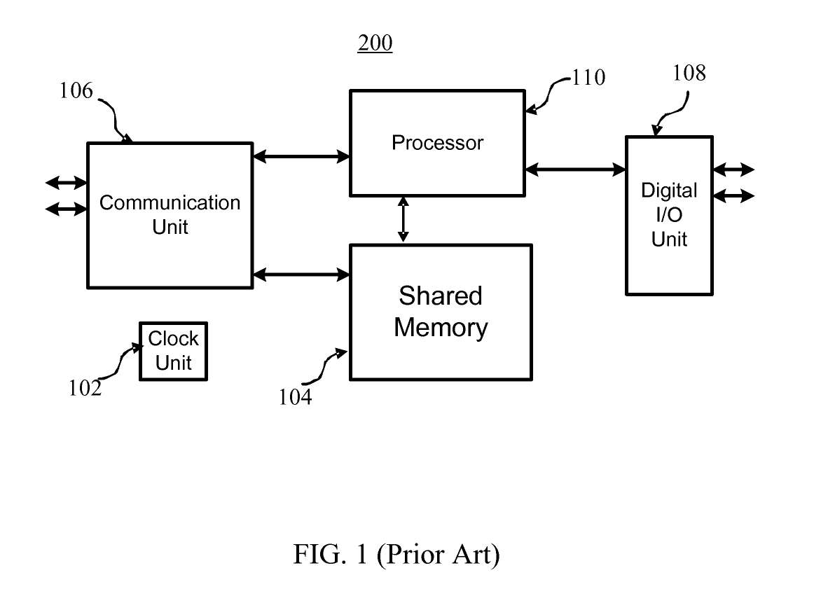

FIG. 1 illustrates a prior-art processing device 200 that includes a memory module 104, a processor 110, a communication unit 106, a digital IO unit 108, and a clock unit 102. Each component is connected to other components in the system to perform intended functions. In this illustrated example, memory module 104 is connected to the processor 110 and the communication unit 106. Processor 110 connects to memory module 104 to receive instructions and data for execution. The communication unit 106 is connected to processor 110 to trigger execution of instructions for detected activities. The communication unit 106 can be sensor devices such as listening sensor, watching sensor, and medical-condition monitoring sensor. The communication unit 106 can be wire connection such as LAN. The communication unit 106 can also be wireless connection such as WiFi or Bluetooth devices or cell phone signal. The communication unit 106 can send data for storage in memory module 104. Processor 110 is also connected to digital IO unit 108 for further executing of data. Examples of the digital IO unit 108 are display screen, printer, and keyboard. The digital IO unit 108 is also capable of sending data to processor 110 for execution of specific instructions and/or data. The clock unit 102 providing the clock signal to all processing units within processing device 200. The clock unit 102 is often a PLL with many large clock buffers for clock signals to all processing units. A clock tree is designed to connect and provide adequate clock signals to all processing units. The large processing unit can implement its own PLL with its own clock tree. Clock gate can be implemented to disable the clock to functional blocks within the processing unit but the PLL and the clock tree will continue to run and dissipate power.

In the processor 110, the PLL clock frequency can operate at multiple of clock frequency of the clock unit 102. The internal clock of processor 110 connects to an internal clock tree to supply clock to all internal functional units, storage components such as instruction and data caches, and bus interface unit. Memory module 104 may use the PLL clock in different manner than processor 110. One such purpose is multiple internal clocks with different clock frequencies for internal SRAM or DRAM arrays and I/O interfaces with processor 110 and the communication unit 106. The I/O interface of the memory module 104 can be at the same clock frequency with processor 110 and the communication unit 106. The memory module 104 may include memory controller logic and secure access protocol controller.

In alternate embodiment, processing device 200 may include any number of processors, hardware accelerators, and I/O devices. In another embodiment, the processor 110 may be a DSP processor or graphic unit. The memory module 104 may include memory modules and hierarchical memory subsystem for processors 110.

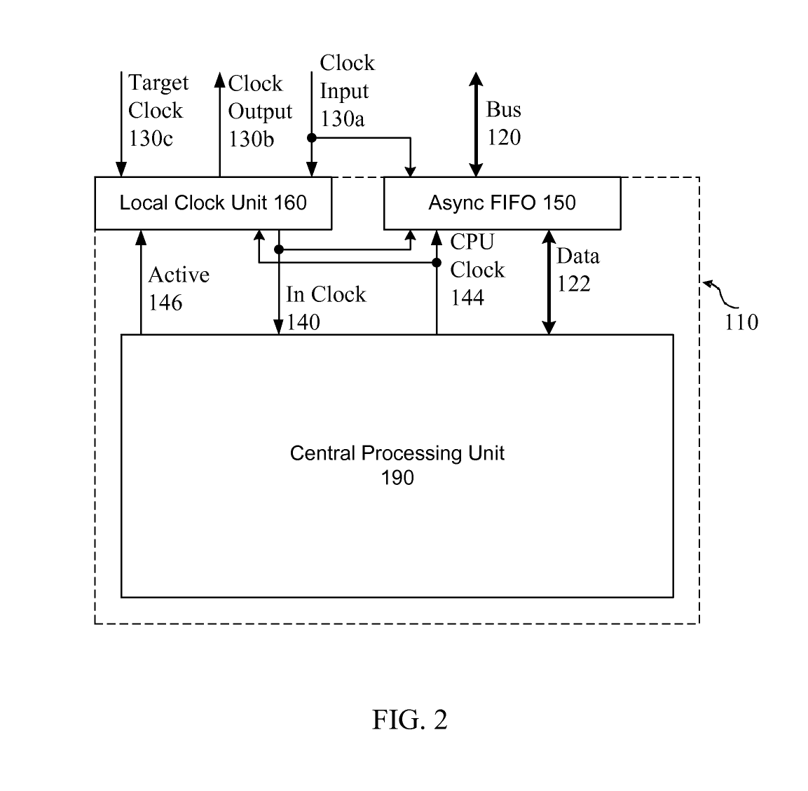

FIG. 2 is a diagram of an embodiment of interfaced clock unit and asynchronous FIFO that can be included in a processor 110 of FIG. 1. Note that the black dot on the crossing lines indicates the same wire connection of the same signal branching out to multiple blocks. In this illustrated example, the processor 110 includes asynchronous FIFO 150, local clock unit 160, and central processing unit 190. The central processing unit 190 may include instruction fetch, instruction decode, register file, execute unit, load store unit, and instruction/data caches. All functional units within the central processing unit 190 include self-clock modules for low power operation as suggested in previous patent application. The central processing unit 190 is activated when a valid clock signal 140 is asserted. Data from an external processing unit is received on bus 120 to asynchronous FIFO 150. The local clock unit 160 is enabled by clock input 130a to generate internal clock 140 to read valid data from asynchronous FIFO 150 to the central processing unit 190.

The local clock unit 160 is responsible for interfacing with external devices at different clock frequency as well as with a CPU clock signal 144 from central processing unit 190. The asynchronous FIFO 150 receives CPU clock signal 144 and output data 122 from central processing unit and the local clock unit 160 generates output clock signal 130b to an external processing unit for valid data on bus 120. The CPU clock signal 144 indicates that valid data 122 is sent from central processing unit 190 to asynchronous FIFO 150. The local clock unit 160 also receives input clock signal 130a and input data on bus 120 from external processing unit to generate internal clock signal 140. Since the processing unit 110 in FIG. 1 can operate at different clock frequency than other processing units such as memory module 104, the asynchronous FIFO 150 is necessary to buffer for interfacing with other processing units. Data are queued and synchronized in both directions. The local clock unit 160 generates an internal clock 140 that is synchronized with its own clock or input clock 130a depended on the state of the processor 110. The central processing unit 190 provides the active signal 146 for selection of clock signal for synchronization. The processor 110 can be in two states: active or idle. Active state means that there is pending operation within the central processing unit 190 and at least one of the local clocks within the central processing unit 190 is running. Internal logic of central processing unit 190 generates active signal 146 to indicate that the processor is in active state. The active state may base on a valid issued instruction which has not been retired or idle indications from all the functional units of the central processing unit 190.

In another embodiment, a target clock 130c is connected to the local clock unit 160 to set the clock frequency of the internal clock 140 to match with a target clock frequency.

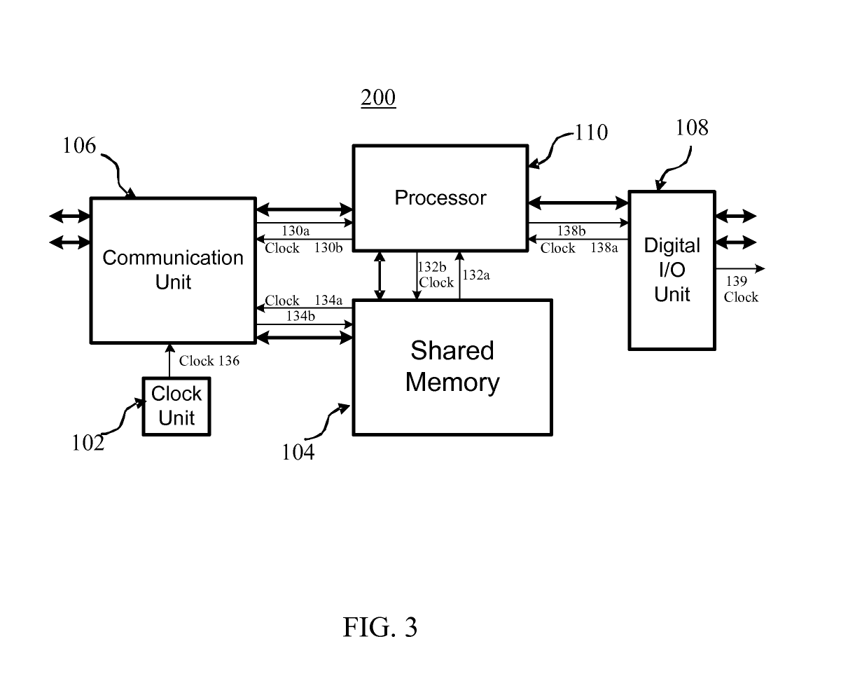

Referring now to FIG. 3, the processing device 200 in FIG. 1 is modified with new clock distribution and clock configurations in accordance with the present invention. The clock unit 102 is now connected to only the communication unit 106 through clock signal 136. Since clock unit 102 is used for the expected interface with external devices at fixed clock frequency, the PLL of clock unit 102 can be scaled down to minimal size. Within the communication unit 106, the local self-clock can be generated to match the clock frequency of the clock unit 102. Clock output 136 of clock unit 102 is used only for clock edge synchronization and initial setting clock period of the communication unit 106. The communication unit 106 generates clock signals 130a and 134a to be sent with data to processor 110 and memory module 104, respectively. Vice versa, the processor 110 and memory module 104 send clock signals 130b and 134b, respectively, in reversed direction along with data to the communication unit 106. The processor 110 is further connected through clock signal 132b and 138b along with data to memory module 104 and digital IO unit 108, respectively. Vice versa, the memory module 104 and digital IO unit 108 send clock signals 132a and 138a, respectively, in reversed direction along with data to processor 110. In addition, the digital IO unit 108 also sends data and clock output 139 to external devices for synchronization. In another embodiment, the clock output 139 can be set to the same clock frequency of clock unit 102. In this case, the clock signal 136 of clock unit 102 can also connect to digital IO unit 108 in order to match the clock frequency of digital IO unit 108 to that of clock unit 102.

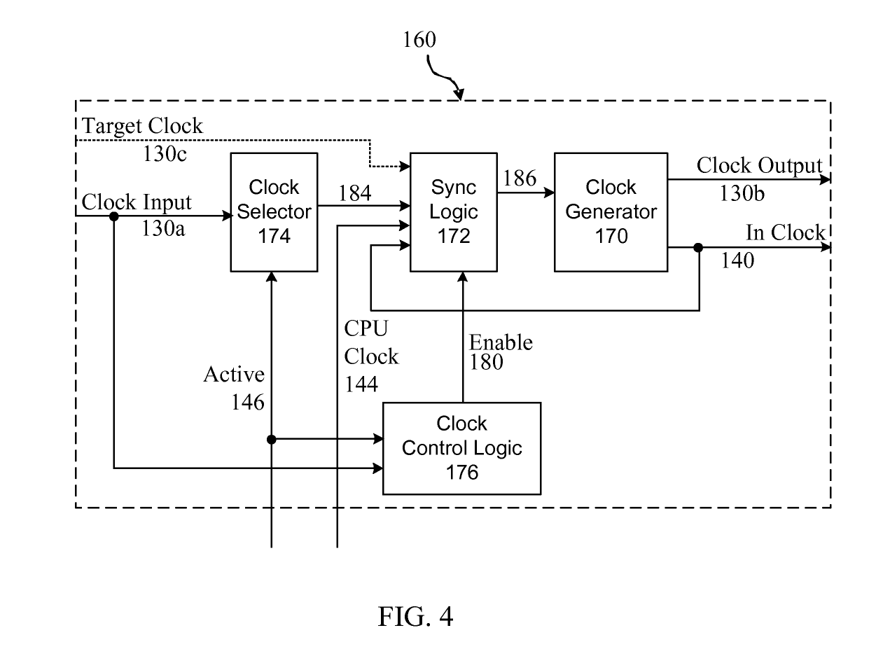

Turning now to FIG. 4, the local clock unit 160 in the processor 110 is shown. The active signal 146 is used by clock control logic 176 to continuously enable the sync logic block 172 to generate clock 186 to clock generator 170 to generate internal clock 140. For processor 110 in active state, the internal clock 140 is running with its own clock-edge synchronization with feeding back of the internal clock 140 to sync logic block 172. Clock synchronization in the context of this invention means that the rising edges of two input clocks are used to produce an output clock based on the later rising edge of the two input clocks. Processor 110 can have many local clock units and, ideally, all the clock signals should have the same rising edge. Clock-edge synchronization logic forces the output clock of a local clock unit to delay to the latest rising edge of the input clocks. The synchronization logic can be an AND gate as described in previous U.S. Pat. No. 5,987,620. In another embodiment, the clock synchronization uses the falling edges of input clocks for clock-edge synchronization. For further discussion of this invention, the rising clock edge is assumed for clock edge synchronization and pipeline operation. When an input to the sync logic block 172 remains in High state, it has no impact on the logic of the sync logic block 172. When an input to the sync logic block 172 is in the Low state, it is effectively disable the output 186 until the rising edge of all clock input signals. For pipeline operation of the processor, the instruction is processed through multiple pipeline stages of the processor based on the clock edge of the internally generated clocks. When the processor 110 is in active state, the internal clock 140 is continuously running and the clock input 130a is not used by local clock unit 160 as it is not selected by the clock selector 174. If a valid clock input 130a is received when the processor is in idle state, the internal clock 140 and the CPU clock 144 are not running, then clock input 130a is selected by clock selector 174 to generate clock signal 184 and is used by clock control logic 176 to enable the sync logic 172. The clock generator 170 generates the internal clock signal 140 with the clock edge arbitrary set to be the same as the clock input 130a for the first cycle. The output clock 184 of clock selector 174 is sent to sync logic block 172 for clock edge synchronization. The clock selector 174 will disable the selection of clock input 130a for subsequent clock generation of the internal clock 140. The sync logic block 172 also receives the CPU clock 144 for synchronization. The CPU clock 144 remains in High state when it is not active. The active CPU clock 144 is sent along with valid data 122 to the asynchronous FIFO 150 as shown in FIG. 2, the CPU clock 144 is synchronized with internal clock 140 to generate internal clock 140 and clock output 130b to external processing unit. The rising edge of output clock 186 is based on the rising edges of all input clocks, 144 and 140 in this case. When the processor 110 is in active state, the clock edge of internal clock 140, CPU clock 144, and other clocks within processor 110 should be at the same clock frequency of internal clock 140 and with synchronized clock edge.

The description of local clock unit 160 is based on processor 110 but it should be understood that it is applicable to any processing unit. For instance, the clock unit 160 can be used for the communication unit 106 where the clock period is set by the clock unit 102. FIG. 4 includes target clock input 130c as input to the sync logic block 172 where the clock rising edge of clock output 186 is delayed until the clock rising edge of target clock 130c, effectively extended the clock period. The clock generator 170 includes a delay chain to match the worst-case timing path of a pipeline stage in the processor 110. The internal clock 140 is generated by clock generator 170 using this delay chain. This clock frequency is the highest possible clock frequency for processor 110 which is the natural clock frequency of processor 110. The clock frequency of target clock input 130c is lower than that of the natural clock frequency of the processor 110. The clock frequency of local clock unit 160 can be lower to match a target clock frequency such as the target clock 130c. The synchronization logic 172 is designed to delay the clock edge of internal clock 140 to match the clock frequency of target clock 130c. The target clock 130c can be at much lower clock frequency for application such as medical monitor devices. In another embodiment, the target clock 130c and input clock 130a are the same clock signal.

Some of the above embodiments, as applicable, may be implemented using a variety of different information processing systems. For example, although FIG. 1 and the discussion thereof describe an exemplary information processing architecture, this exemplary architecture is presented merely to provide a useful reference in discussing various aspects of the disclosure.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the functionality of the above described operations merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

In one embodiment, the local-clocks of this disclosure is applicable to all digital ICs like custom chip, Application Specific IC (ASIC), Field Programmable Gate Array (FPGA). It is applicable to practically any digital design such as processing units, memory systems, communication system, and I/O systems.

In one embodiment, system 200 is a computer system such as an embedded computer system. Other embodiments may include different types of computer systems. Computer systems are information handling systems which can be designed to give independent computing power to one or more users. Computer systems may be found in many forms including but not limited to mainframes, minicomputers, servers, workstations, personal computers, notepads, personal digital assistants, electronic games, internet-of-thing, automotive and other embedded systems, cell phones and various other wireless devices. A typical computer system includes at least one processing unit, associated memory and a number of input/output (I/O) devices.

Although the disclosure is described herein with reference to specific embodiments, various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to specific embodiments are not intended to be construed as a critical, required, or essential feature or element of any or all the claims.

The term “coupled,” as used herein, is not intended to be limited to a direct coupling or a mechanical coupling.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to disclosures containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

1. A digital circuitry comprising:
a processing unit that receives a first clock and comprising of a first self-clock circuitry that generates a first internal clock;
wherein the said first self-clock circuitry further comprises of:
a mechanism to select between the said first clock and a first internal clock of the said processing unit for clock edge synchronization.

2. The apparatus of claim 1, wherein the processing unit further comprises of a first-in-first-out register to receive a data from another processing unit.

3. The apparatus of claim 2, wherein the first internal clock from the self-clock circuitry of the processing unit is used to read a data from the first-in-first-out register.

4. The apparatus of claim 1, wherein the processing unit further comprises a first-in-first-out register to send an output clock and a data to another processing unit.

5. The apparatus of claim 1, wherein the internal clock period of the said self-clock circuitry is designed to match a worst-case delay of an internal pipeline logic of the processing unit.

6. The apparatus of claim 1, wherein the internal clock period of the said self-clock circuitry is designed to match a target clock frequency of an external clock.

7. The apparatus of claim 6, wherein the said external clock is the same as the first clock.

8. The apparatus of claim 1, wherein the said processing unit comprises of a second self-clock circuitry; wherein the second self-clock circuitry generates the second internal clock that:
has the same clock frequency with the first internal clock of the first self-clock circuitry; and
synchronizes with the first internal clock of the first self-clock circuitry.

9. The apparatus of claim 1, wherein the processing unit is:
a memory storage device; or
a communication unit; or
a sensor unit; or
a digital IO device.

10. The apparatus of claim 1, wherein the first self-clock circuitry of the processing unit further comprises of:
an active indication to generate the first internal clock; and
an idle indication to generate no clock.

11. A method of generating an internal clock from a self-clock circuitry of a processing unit, comprising:
receiving a first input clock;
receiving an internal clock;
generating a first output clock;
selecting the said first input clock or the said internal clock for clock edge synchronization to generate the said first output clock.

12. The method of claim 11, wherein the first output clock is the same as the internal clock.

13. The method of claim 11, further comprising of a first-in-first-out register that synchronizes with the first input clock to receive a data from another processing unit.

14. The apparatus of claim 11, further comprising of a first-in-first-out register that sends an output clock and a data to another processing unit.

15. The method of claim 11, further comprising:
generating an active indication to generate the first output clock; and
generating an idle indication to generate no clock.

16. The method of claim 11, wherein the first output clock period is designed to match a worst-case delay of an internal pipeline logic of the processing unit.

17. The method of claim 11, wherein the first output clock period is designed to match a target clock frequency of an external clock.

18. The method of claim 17, wherein the external clock is the same as first input clock.

19. A computer system comprising:
a processing unit,
a memory storage device unit,
an I/O interfacing unit;
wherein communication between the said units including:
a clock signal; and
a valid packet of data;
wherein each of the said units further comprising:
a self-clock circuitry to generate an internal clock and a mechanism to select between an external input clock and a locally generated clock of the processing unit for clock edge synchronization.

20. The computer system of claim 19, wherein the self-clock circuitry of an unit in the said computer system is designed to match:
a worst-case delay of an internal pipeline logic of the said unit; or
a target clock frequency of an external input clock.
